(19) United States
(12) Patent Application Publication
(10) Pub. No.: US 2012/0331440 A1
(43) Pub. Date: Dec. 27, 2012

(54) OPTIMIZED SOFTWARE DEVELOPMENT

(75) Inventors: Jayaram Meermeera, Bangalore (IN); Rupesh Goel, Mumbai (IN); Jayant Dani, Mumbai (IN)

(73) Assignee: Tata Consultancy Services Limited, Mumbai (IN)

(21) Appl. No.: 13/526,823

(22) Filed: Jun. 19, 2012

(30) Foreign Application Priority Data
Jun. 23, 2011 (IN) 1820/MUM/2011

(51) Int. Cl. G06F 9/44

(52) U.S. Cl. 717/101

(57) ABSTRACT

Aspects of optimized software development are described herein. In an implementation, according to a method for optimized software development, specifications of a repetitive-use software asset are published on an open platform over a network to acquire a demand parameter associated with the repetitive-use software asset. The demand parameter is acquired based on the specifications of the repetitive-use software asset. Based on the demand parameter associated with the repetitive-use software asset, a use-commitment indicator is obtained. The use-commitment indicator indicates a commitment for using the repetitive-use software asset. Further, a recommendation for developing the software asset is generated based on the use-commitment indicator.

### CLAIM OF PRIORITY

This application claims the benefit of priority under 35 U.S.C. §119 of Jayaram Meermeera et al., Indian Patent Application Serial Number 1820/MUM/2011, entitled “OPTIMIZED SOFTWARE DEVELOPMENT,” filed on Jun. 23, 2011, the benefit of priority of which is claimed hereby, and which is incorporated by reference herein in its entirety.

### TECHNICAL FIELD

The present subject matter relates, in general, to software development and, in particular, relates to optimized software development.

### BACKGROUND

The ever-dynamic software industry constantly witnesses development of new software products. The software products may include both complete software applications and standalone sub-modules of the software application. Such software products are generally developed for a specific purpose, such as banking software for banking, or an accounting software for use in keeping accounts. With the increasing demand for cost optimization, the optimization of software development process is desired.

In recent times, reuse of software products has been identified as one of the solutions for rapid development and deployment of the software products. More often than not, a software product developed for a certain application or a component of that product can be modified and reused in another application similar to the application for which it was earlier developed.

### SUMMARY

This summary is provided to introduce concepts related to optimized software development. These concepts are further described below in the detailed description. This summary is not intended to identify essential features of the claimed subject matter nor is it intended for use in determining or limiting the scope of the claimed subject matter,

Aspects of optimized software development are described herein. In an implementation, according to a method for optimized software development, specifications of a repetitive-use software asset are published on an open platform over a network to acquire a demand parameter associated with the repetitive-use software asset. The demand parameter is acquired based on the specifications of the repetitive-use software asset. Based on the demand parameter associated with the repetitive-use software asset, a use-commitment indicator is obtained. The use-commitment indicator indicates a commitment for using the repetitive-use software asset. Further, a recommendation for developing the software asset is generated based on the use-commitment indicator.

### BRIEF DESCRIPTION OF DRAWINGS

The detailed description is described with reference to the accompanying figure(s). In the figure(s), the left-most digit(s) of a reference number identifies the figure in which the reference number first appears. The use of the same reference number in different figure(s) indicates similar or identical items. The features, aspects and advantages of the subject matter will be better understood with regard to the following description, and the accompanying drawings.

FIG. 1 illustrates a network environment implementing a computing system for optimized software development, in accordance with an implementation of the present subject matter.

FIG. 2 illustrates a computing system for optimized software development, in accordance with an implementation of the present subject matter.

FIG. 3 illustrates a method for optimized software development, in accordance with an implementation of the present subject matter.

### DETAILED DESCRIPTION

The present subject matter relates to methods and systems for optimized software development. Methods and systems related to optimized software development as described herein can be implemented in a variety of devices, such as a server, a desktop personal computer, a notebook or a portable computer, a mainframe computer, or a mobile computing device.

Conventionally, techniques have been identified for developing software products in such a way that the software products can be used in other applications. The challenge faced in reusability of an existing software product to serve a demand for a new software product is that adapting the software product to another application may incur considerable cost in customization, testing, and deployment. In light of the challenges for reusing software products, particularly the additional cost incurred, failure to create a demand for reuse of the software product can have an adverse economic influence on the parties investing in the development of the software product. Therefore, focused attempts at developing multi-application software products are not a commonplace practice.

The present subject matter relates to methods and systems for optimized software development. The optimization of software development includes development of a repetitive-use software asset. The repetitive-use software asset can be understood as a multi-application software code, which may be reused as a functional component in a software product other than the software product for which the repetitive-use software asset is originally developed. According to an aspect of the present subject matter, specifications and functionalities of the repetitive-use software asset to be developed are made public by software providers on an open platform, for example, the intranet, shared by a group of software developers in an organization or a communication network shared by software developers in different collaborating organizations. The software providers can be understood as software developers who are developing the multi-application software.

In an implementation, the specifications of the repetitive-use software asset can be provided using a questionnaire on the open platform. The specifications of the repetitive-use software asset can include the various functionalities and the applications where the repetitive-use software asset can be further used. In an example, the specifications of the repetitive-use software asset may include the requirement of the developer with respect to the repetitive-use software asset, the variations to be made in the repetitive-use software asset, the possible applications of the repetitive-use software asset, and the time for implementing the repetitive-use software asset.

Further, based on the specifications of the repetitive-use software asset, a demand parameter associated with the repetitive-use software asset is obtained from potential users out of the various software developers on the open platform. The demand parameter, in one implementation, is a measure of the demand of the repetitive-use software asset for use in different softwares by the software developers. In an example, each demand parameter can be a quantitative parameter having a predetermined threshold score associated with it. In said example, the demand of the repetitive-use software asset among the software developers is measured based on the number of demand parameters obtained having the predetermined threshold score or a greater score. As will be understood, the software developers providing the demand parameter having at least the predetermined score are referred to as the potential users.

In an implementation, once the demand parameter has been captured from the developers on the open platform, a use-commitment indicator is requested from the potential users out of the various developers. The use-commitment indicator can indicate an agreement or a promise by the potential users of the repetitive-use software asset to use and deploy the repetitive-use software asset within a predetermined period, say within 6 months, after the completion of development and testing of the multi-application software. In one example, the use-commitment indicator can be a flag, which can be shared over the open platform to indicate the use-commitment of the software developer. Based on the receipt of the use-commitment indicator from the potential users, one or more collaborators are identified from among the potential users. The collaborators can be understood as those software developers who have shown an interest in the development of the repetitive-use software asset and who are also willing to provide a use-commitment indicator for reusing the repetitive-use software asset.

Further, a request to vote can be sent to each potential user to ascertain the inclination of the potential users towards the development and use of the repetitive-use software asset. Hence, the present invention can also allow involvement of the potential users in determining the significance of developing the software for reuse by other developers. The potential users may also provide inputs on various aspects related to the development or application of the repetitive-use software asset. For example, the potential user may contribute in providing inputs on the various possible applications of the repetitive-use software asset and course corrections for development of the repetitive-use software asset.

Subsequently, based on the number of votes in favour of development of the repetitive-use software asset, an opinion is taken from an expert on the viability of developing the repetitive-use software asset in line with the requirements of the potential users who have committed for future use of the repetitive-use software asset. In an implementation, the expert validates whether the repetitive-use software asset can be custom-fitted to conform to the requirements of the potential users and the cost effectiveness of such a modification of the repetitive-use software asset. The expert can also provide inputs on improving the economic and technical viability of the repetitive-use software asset in terms of the requirements of the potential user of the repetitive-use software asset.

On obtaining the inputs from the expert, the developer may decide whether to proceed with the development of the repetitive-use software asset or not. Based on the expert opinion, the repetitive-use software asset may be developed, tested, and provided to the potential users for further deployment. In one example, the potential users can verify and evaluate the utility and profitability of the repetitive-use software asset against the originally captured demand by way of the demand parameter, and provide the inputs.

While aspects of described systems and methods for optimized software development can be implemented in any number of different computing systems, environments, and/or configurations, the embodiments are described in the context of the following system architecture(s).

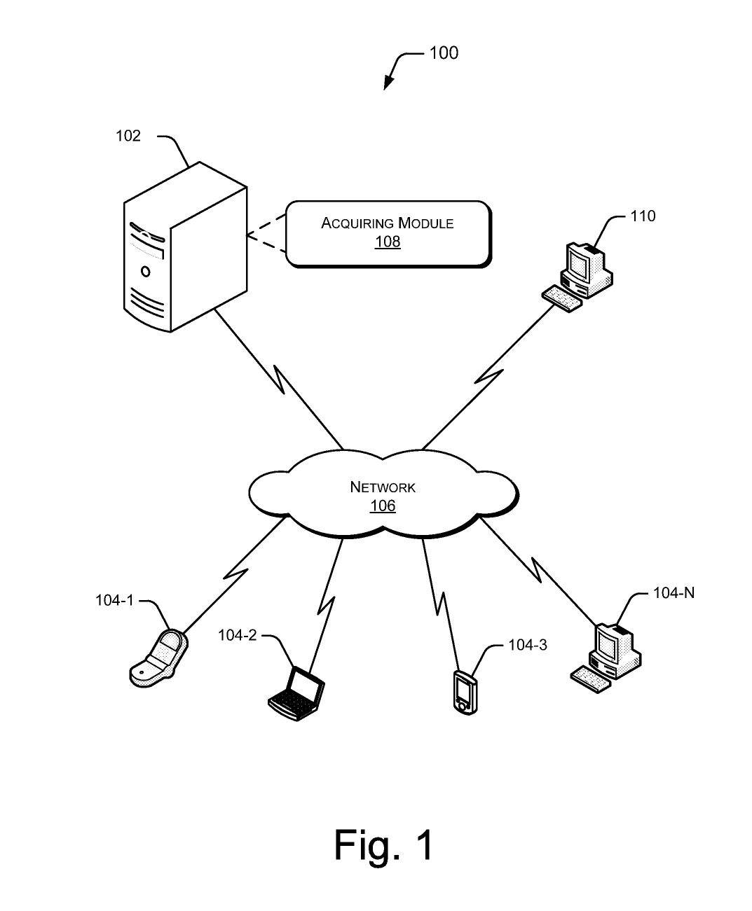

FIG. 1 illustrates a network environment 100 implementing a computing system 102 for optimized software development, according to an implementation of the present subject matter. In said embodiment, the computing system 102 is connected to a plurality of user devices 104-1, 104-2 . . . 104-N, collectively referred to as the user devices 104 and individually referred to as a user device 104. The computing system 102 and the user devices 104 may be implemented as any of a variety of conventional computing devices, including, for example, servers, a desktop PC, a notebook or portable computer, a workstation, a mainframe computer, a mobile computing device, an entertainment device, and an internet appliance.

The computing system 102 is connected to the user devices 104 over a network 106 through one or more communication links. The communication links between the computing system 102 and the user devices 104 are enabled through a desired form of communication, for example, via dial-up modem connections, cable links, digital subscriber lines (DSL), wireless or satellite links, or any other suitable form of communication.

The network 106 may be a wireless network, a wired network, or a combination thereof. The network 106 can also be an individual network or a collection of many such individual networks, interconnected with each other and functioning as a single large network, e.g., the Internet or an intranet. The network 106 can be implemented as one of the different types of networks, such as intranet, Local Area Network (LAN), Wide Area Network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include network devices, such as network switches, hubs, routers, Host Bus Adapters (HBAs), for providing a link between the computing system 102 and the user devices 104. The network devices within the network 106 may interact with the computing system 102 and the user devices 104 through the communication links.

In one implementation, the network environment 100 can be a company network, including thousands of office personal computers, laptops, various servers, such as blade servers, and other computing devices connected over the network 106. In another implementation, the network environment 100 can be the size of a home network, with a limited number of personal computers and laptops connected over the network 106.

Further, in an implementation, the network environment 100 includes an auxiliary device 110 connected to the computing system 102 through the network 106. In one example, the auxiliary device 110 is provided with one or more experts for, for example, achieving interaction between the experts and software providers operating the computing system 102. In one example, the expert can be an academician in the field of software development. Although the auxiliary device 110 is depicted as having a different configuration from the computing system 102, it will be understood that the auxiliary device 110 may have a configuration that is same or similar to the computing system 102 or one of the user devices 106.

The computing system 102 includes an acquiring module 108 for achieving optimized software development. In an implementation, the computing system 102 provides specifications on functionalities and operation of a repetitive-use software asset to be developed. The repetitive-use software asset can be understood as a software code which can be used in one or more large software application other than the software application that the software is originally developed for.

The specifications of the functionalities and operation of the multi-application software can be published on an open platform, for example, a common repository (not shown in figure), over the network 106. With the publication of the specifications over the network 106, the specifications are accessible by a group of software developers in an organization or those in different collaborating organizations through the user devices 104. In one example, the specifications of the multi-application software can be provided on the open platform in the form of a questionnaire completed by one or more software providers of the multi-application software. The software providers can be understood as those software developers who are planning to develop and launch the repetitive-use software asset for reusable purposes.

Based on the specifications and functionalities of the repetitive-use software asset, the acquiring module 108 obtains a demand parameter associated with the repetitive-use software asset from potential users among the various software developers interacting with and accessing the open platform. The demand parameter can be understood as a measure of the demand of the repetitive-use software asset for use in different softwares by the software developers. In an example, each demand parameter can be a quantitative parameter having a predetermined score, say on a scale of 10. In said example, the demand of the repetitive-use software asset among the software developers is measured based on the number of demand parameters having a predetermined threshold score, obtained by the acquiring module 108.

In an implementation, the acquiring module 108 is configured to request to receive the demand parameter from each of the software developer accessing the specifications of the multi-application software on the open software. According to said implementation, the acquiring module 108 can interact with the various user devices 104 operated by the software developers and obtain the demand parameter associated with the repetitive-use software asset.

Further, the acquiring module 108 is configured to select one or more software developers from whom the demand parameter is captured, and categorize such selected software developers as potential users. As described earlier, the potential users can be selected based on the score provided by them with the demand parameter. For example, the software developers providing a score greater than the predetermined threshold score are selected as potential users. In an implementation, the acquiring module 108, after identifying and selecting the potential users, can interact with the respective user devices 104 and request for contact and personal information of each of the software developers selected as the potential user.

In an implementation, after the acquiring module 108 selects and identifies the potential users of the repetitive-use software asset, the acquiring module 108 acquires a use-commitment indicator from each of the potential users. In said implementation, the acquiring module 108 can send a request to each of the user devices 104 operated by the identified potential users and request for the use-commitment indicator. In one example, the use-commitment indicator indicates an agreement between the software provider and the potential users of the repetitive-use software asset, and serves as an undertaking from the potential user to use the repetitive-use software asset after development and testing. Further, in an implementation, the repetitive-use software asset is provided for use to the potential users after the multi-application software has been deployed in the software application for which it is originally developed.

Based on the potential users providing the use-commitment indicator, such potential users being referred to as collaborators hereinafter, the acquiring module 108 obtains a vote regarding the development of the repetitive-use software assets from each of the collaborators. In an implementation, the acquiring module 108 sends a voting request to each of the collaborators identified from the potential users. The voting can be done to assess the willingness of the collaborators towards the reuse of the repetitive-use software asset. In an implementation, the acquiring module 108 can also send request to the user devices 104 operated by the collaborators to obtain inputs and suggestions regarding the development of the repetitive-use software asset.

Further, the computing system 102 assesses the votes obtained from the collaborators in favour of the development of the repetitive-use software asset, and based on the assessment, an expert opinion regarding the development of the multi-application software is obtained. In one implementation, the computing system 102 interacts with the auxiliary device 110 and sends a request to the expert to provide inputs regarding the development of the repetitive-use software asset. The expert is involved in the process of software development so that the viability and profitability of developing the repetitive-use software asset can be assessed. Additionally, the expert opinion provides an insight in order to take the final decision on whether to go ahead or suspend the development of the repetitive-use software asset.

Based on the expert opinion, the computing system 102 ascertains the technical and commercial feasibility of developing the repetitive-use software asset and provides a recommendation to either develop the repetitive-use software asset or to suspend the development. In one implementation, the acquiring module 108 is configured to monitor the activity regarding the access of the specifications of the repetitive-use software asset for a predetermined period of time, for example, 6 months. On the basis of the monitoring, the acquiring module 108 is further configured to send requests to the user devices 104 operated by the software developers accessing the specifications of the repetitive-use software asset in the manner as described before. As explained previously, the requests sent by the acquiring module 108 to the user devices 104 include requests to obtain the demand parameter with respect to the repetitive-use software asset.

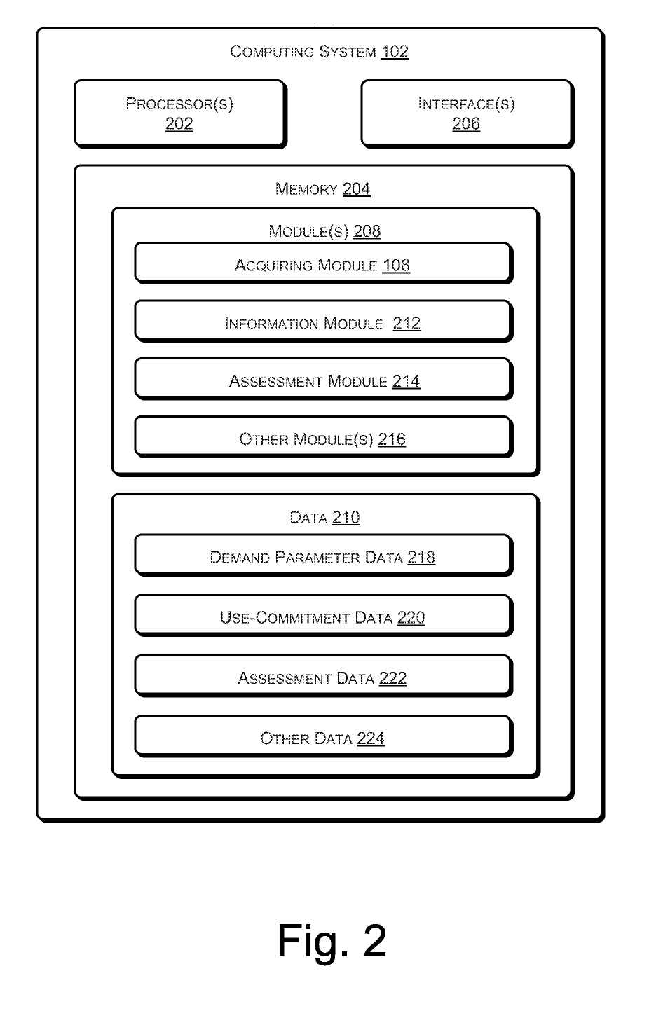

The manner in which optimized software development is implemented is further explained in detail in conjunction with FIG. 2. FIG. 2 illustrates components of the computing system 102 for achieving optimized software development, according to an implementation of the present subject matter.

In one implementation, the computing system 102 includes processor(s) 202 coupled to a memory 204. The computing system 102 further includes interface(s) 206, for example, to facilitate communication with the user devices 104 and the auxiliary device 110. The interface(s) 206 may include a variety of software and hardware interfaces, for example, interfaces for peripheral device(s), such as a keyboard, a mouse, an external memory, and a printer. Further, the interface(s) 206 enables the computing system 102 to communicate with other devices, such as web servers and external repositories. The interface(s) 206 can also facilitate multiple communications within a wide variety of networks and protocol types, including wired networks, for example LAN, cable, etc., and wireless networks such as WLAN, cellular, or satellite. For the purpose, the interface(s) 206 may include one or more ports.

The processor(s) 202 may be implemented as one or more microprocessors, microcomputers, microcontrollers, digital signal processors, central processing units, state machines, logic circuitries, and/or any devices that manipulate signals based on operational instructions. Among other capabilities, the (processor(s) 202 are configured to fetch and execute computer-readable instructions stored in the memory 204.

The memory 204 may include any non-transitory computer-readable medium known in the art including, for example, volatile memory, such as Static Random Access Memory (SRAM), Dynamic Random Access Memory (DRAM), etc., and/or non-volatile memory, such as Erasable Program Read Only Memory (EPROM), and flash memory. The non-transitory computer-readable medium, however, excludes a transitory, propagating signal.

Further, the memory 204 includes module(s) 208 and data 210. The module(s) 208 include, for example, the acquiring module 108, an information module 212, an assessment module 214, and other module(s) 216. The other module(s) 216 may include programs or coded instructions that supplement applications or functions performed by the computing device 102. The module(s) 208 include routines, programs, objects, components, data structures, etc., which perform particular tasks or implement particular abstract data types. In another implementation, the module(s) 208 may be implemented as, signal processor(s), state machines, logic circuitries, and/or any devices or components that manipulate signals based on operational instructions.

The data 210 includes a demand parameter data 218, a use-commitment data 220, an assessment data 222, and other data 224. The other data 224, amongst other things, may serve as a repository for storing data that is processed, received, or generated as a result of the execution of one or more modules in the module(s) 208. Although the data 210 is shown internal to the computing system 102, it may be understood that the data 210 may reside in an external repository (not shown in the figure), which is coupled to the computing system 102. The computing system 102 may communicate with the external repository through the interface(s) 206 to obtain information from the data 210.

In an implementation, the information module 212 receives the specifications regarding the functionality and operation of the repetitive-use software asset, which is under consideration for development. Such specifications regarding the repetitive-use software asset are stored by the information module 212 in the other data 224. In an implementation, the information module 212 provides an input form, such as a questionnaire, to the software providers to list down the specifications of the repetitive-use software asset. The specifications of the repetitive-use software asset as provided by the software provider to the information module 212 can also include the various utilities and applications that may use the multi-application software. As described earlier, the software providers can be understood as software developers who are considering the option of developing the multi-application software with the use of the computing system 102.

Upon receiving the specifications of the repetitive-use software asset from the software provider, the information module 212 provides the specifications for shared public access. In one implementation, the information module 212 publishes the specifications on an open platform, for example, a common repository, over the network 106 for access to various software developers sharing the network 106 in an organization or within collaborating organizations. In one example, the specifications are provided by the information module 212 by filling a template presentation with the specifications of the repetitive-use software asset. The software developers can access the specifications and provide their inputs to the information module 212 regarding the multi-application software. For example, the software developers can interact with the information module 212 and provide their comments on various issues related to the multi-application software, for example, development strategies for the multi-application software and additional applications of the software.

Further, as described previously, the acquiring module 108 acquires the demand parameter associated with the repetitive-use software asset from the various software developers interacting over the network 106. In an implementation, the acquiring module 108 can send a request to the user devices 104 operated by the software developers and assess the demand of the multi-application software based on the demand parameter.

Further, the acquiring module 108 selects and identifies the user devices 104 from which a demand parameter for the multi-application software is obtained, and sends a request to each such user device 104 for obtaining information regarding the software developer operating the user device 104. The software developer from whom the demand parameter is obtained is tagged as a potential user of the repetitive-use software asset. According to an implementation, the acquiring module 108 receives the information of the potential user, such as the name, postal address, contact number, and email address, and stores it in the demand parameter data 218. Further, the acquiring module 108 can also store device information of the user device 104 in the demand parameter data 218 along with the software developer information. The device information of the user device 104 can include, for example, an International Mobile Equipment Identity (IMEI) number of the user device 104, a phone number associated with the user device 104, an IP address of the user device 104, such as the user device 104-1, or an email address of the potential user communicating with the communicating system 102 through the user device 104.

Once the potential users have been identified and their information gathered, the acquiring module requests a use-commitment indicator from each of the potential users, by interacting with the respective user devices 104. As explained earlier, the use-commitment indicator can, in one example, indicate an arrangement between the software provider and the potential user, in which the potential user gives an assurance to reuse the repetitive-use software asset after the software has been developed and deployed in the software application, for which it is originally considered for development.

In an implementation, the acquiring module 108 can receive the use-commitment indicator from the potential users through the user devices 104 and store the specifications of the potential users and the use-commitment indicator in the use-commitment data 220. Further, the acquiring module 108 stores those potential users and the associated user devices 104, from whom the use-commitment indicator is received in the use-commitment data 220. As mentioned earlier, such potential users, from whom the use-commitment indicator is received, are referred to as collaborators. Further, the acquiring module 108 can also allow the collaborators to provide their inputs on the various aspects related to the multi-application software and its development thereof.

In an implementation, after the use-commitment indicator has been received from the collaborators, the acquiring module 108 can request the collaborators to cast a vote for assessing the willingness of the collaborators towards the development of the repetitive-use software asset. The votes provided by the various collaborators are stored in the assessment data 222. Further, the assessment module 214 can access the assessment data 222 and based on a proportion of votes in favour of the development of the multi-application software, the assessment module 214 can interact with the auxiliary device 110 to interact with the expert. The assessment module 214 can request for an opinion from the expert by providing the specifications of the repetitive-use software asset and the various inputs received from the software providers interacting on the open platform. The expert can, in turn, provide inputs on the technical and economical feasibility of the development of the repetitive-use software asset.

Based on the inputs and the suggestions of the expert, the assessment module 214 can provide a suggestion to the computing system 102 and to the software providers to either proceed with the development of the repetitive-use software asset or, for the time being, defer the development of the software.

In case the development of the software is deferred, in an implementation, the acquiring module 108 is configured to request inputs from the various software developers after lapse of a predetermined period of time, for example, 6 months. In said implementation, the acquiring module 108 request inputs from the software developers interacting with the computing system 102 and checks whether the development of the repetitive-use software asset is technically and economically feasible.

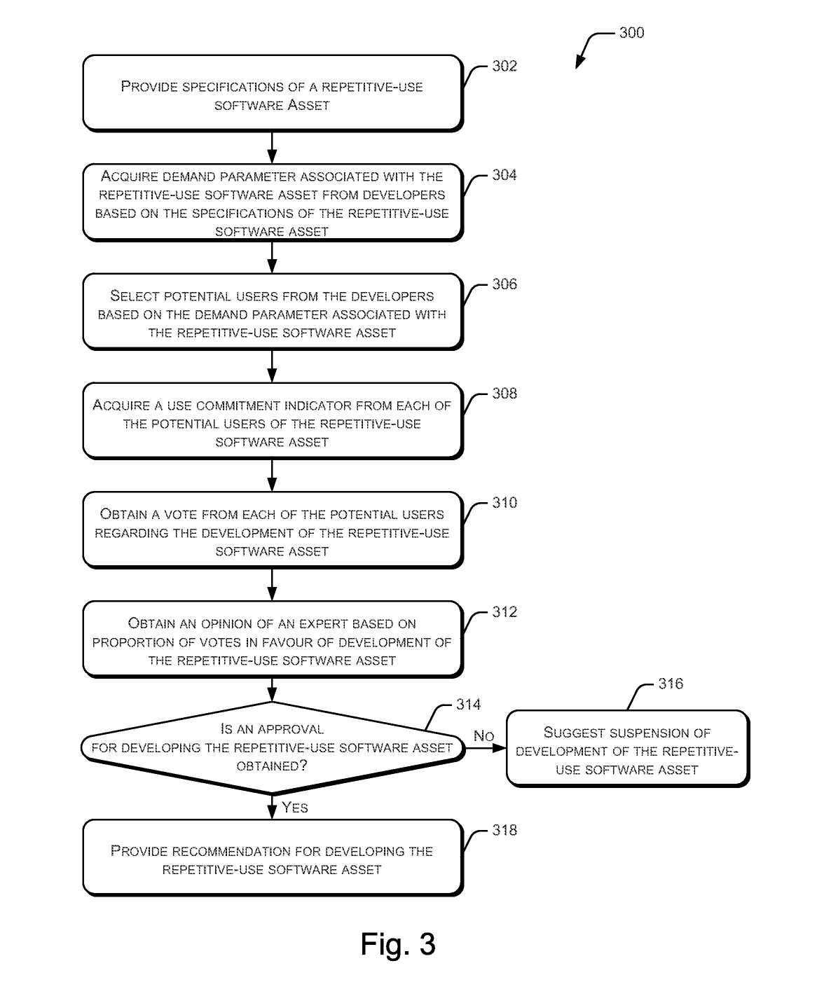

FIG. 3 illustrates a method 300 for achieving optimized software development, according to an implementation of the present subject matter. Although, description for the method 300 is provided below with reference to the computing system 102, it will be understood that the method 300 can be carried out by other systems and devices.

The method 300 may be described in the general context of computer executable instructions embodied on a computer-readable medium. Generally, computer executable instructions can include routines, programs, objects, components, data structures, procedures, modules, and functions, which perform particular functions or implement particular abstract data types. The method may also be practiced in a distributed computing environment where functions are performed by remote processing devices that are linked through a communications network. In a distributed computing environment, computer executable instructions may be located in both the local and the remote computer storage media, including memory storage devices.

The order in which the method 300 is described is not intended to be construed as a limitation, and any number of the described method blocks can be combined in any order to implement the method 300, or an alternative method. Additionally, individual blocks may be deleted from the method 300 without departing from the spirit and scope of the methods, systems and devices described herein. Furthermore, the method 300 can be implemented in any suitable hardware, software, firmware, or combination thereof.

Referring to FIG. 3, at block 302 specifications of a repetitive-use software asset are provided for access. The specifications of the repetitive-use software asset can include the various functionalities of the repetitive-use software asset and the different applications, in which the repetitive-use software asset can be embedded for deployment. In one example, the specifications of the repetitive-use software asset are received from one or more software providers by the information module 212. In said example, the specifications are provided by the software providers to the information module 212 by filling a template presentation with the specifications of the repetitive-use software asset. Further, in said example, the information module 212 can publish the specifications for access to various software developers on an open platform over the network 106. The open platform can be a repository, which is accessible by the information module 212 as well as the software developers.

At block 304, based on the specifications of the multi-application, a demand parameter associated with the multi-application software is acquired from the various software developers. The demand parameter, in one implementation, is a measure of the demand of the repetitive-use software asset for use in different softwares by the software developers. In said implementation, the demand parameter can be a score associated with the repetitive-use software asset. For example, the acquiring module 108 can request and obtain the demand parameter for the repetitive-use software asset from the software developers. In one implementation, along with the demand parameter, other inputs, such as suggestions for development and software applications where the repetitive-use software asset may find use, can also be requested and obtained from the software developers.

Further, at block 306, potential users of the repetitive-use software asset are selected from among the software developers. In one example, the acquiring module 108 selects those software developers as the potential users, who have provided a predetermined threshold score in the demand parameter for the repetitive-use software asset. In said example, the acquiring module 108 can identify and select the user devices 104 associated with potential user from each of such user devices 104 and request personal information.

The requested information can include the name, postal address, contact number, and email address of the potential users. Further, device information of each of the user devices 104 can also be obtained by the acquiring module 108. The device information of the user device 104 can include, for example, an International Mobile Equipment Identity (IMEI) number of the user device 104, a phone number associated with the user device 104, an IP address of the user device 104, such as the user device 104-1, or an email address of the potential user communicating with the communicating system 102 through the user device 104.

After identifying and selecting the potential users of the repetitive-use software asset, at block 308, a use-commitment indicator is acquired from each of the potential users. The use-commitment indicator can indicate an agreement between the software provider and the potential user, under which the potential user commits to reuse the repetitive-use software asset developed by the software provider. In one implementation, the acquiring module 108 sends a use-commitment request to the identified potential users. Further, the acquiring module 108 can also identify and tag the potential users from whom the use-commitment indicator is obtained, and such potential users are tagged as collaborators, for example, by tagging the user device 104 associated with the potential user.

At block 310, a vote in regard of the repetitive-use software asset is acquired from the potential users. In one example, the acquiring module 108 sends a voting request to the potential users tagged as collaborators and receives the votes of the potential users. Further, in an example, the assessment module 214 ascertains the proportion of votes in favour of the development of the repetitive-use software asset from among the total number of votes received in relation to the repetitive-use software asset.

At block 312, based on the proportion of votes in favour of development of the repetitive-use software asset, an expert opinion is obtained. In one implementation, the proportion of votes in favour of development of the software is greater than 50% for the expert opinion to be obtained. In one example, the assessment module 214 sends a request to the auxiliary device 110 to interact with the expert and request for opinion. The expert may, in turn, interact with the computing system 102 through the auxiliary device 110 and provide inputs on technical and economical feasibility of developing the repetitive-use software asset.

Based on the approval of the expert on the development of the multi-application software at block 314 (‘Yes’ path from block 314), a recommendation for developing the multi-application software is provided to the software provider at block 318. In one example, the recommendation is generated by the assessment module 214. On the other hand, in case an approval of the expert opinion is not obtained at block 314 (‘No’ path from block 314), then the assessment module 214 generates a suggestion to suspend the development of the repetitive-use software asset and provides the suggestion to the software provider at block 316.

Further, upon the lapse of a predetermined period of time, for example, after 6 months, method 304 may be carried out again by the computing system 102.

Although implementations for optimized software development have been described in language specific to structural features and/or methods, it is to be understood that the present subject matter (and not appended claims) is not necessarily limited to the specific features or methods described. Rather, the specific features and methods for optimized software development are disclosed as implementations of the present invention.

I/we claim:

1. A method for optimized software development, the method comprising:
publishing specifications of a repetitive-use software asset on an open platform over a network to acquire a demand parameter associated with the repetitive-use software asset, wherein the demand parameter is acquired based on the specifications of the repetitive-use software asset;
obtaining a use-commitment indicator indicating a commitment for using the repetitive-use software asset based on the demand parameter associated with the repetitive-use software asset; and
generating a recommendation for developing the repetitive-use software asset based on the use-commitment indicator.

2. The method as claimed in claim 1, wherein the providing the specifications comprises populating a template presentation with specifications of the repetitive-use software asset.

3. The method as claimed in claim 1, wherein the generating the recommendation comprises obtaining a plurality of votes regarding development of the repetitive-use software asset based on the use-commitment indicator.

4. The method as claimed in claim 3, wherein the generating the recommendation further comprises obtaining an approval of an expert for the development of the repetitive-use software asset based on a predetermined proportion of votes in favour of the development of the repetitive-use software asset.

5. The method as claimed in claim 1, wherein the generating the recommendation comprises providing a suggestion for deferring development of the multi-application software asset.

6. A computing system for optimized software development, the computing system comprising:
a processor; and
a memory coupled to the processor, the memory comprising,
an acquiring module configured to:
obtain a demand parameter associated with a repetitive-use software asset based on specifications of the repetitive-use software asset, wherein the demand parameter is obtained over a network;
acquire a use-commitment indicator for deploying the repetitive-use software asset based on the demand parameter; and
an assessment module configured to provide a recommendation regarding development of the repetitive-use software asset.

7. The computing system as claimed in claim 6, wherein the assessment module is further configured to obtain an opinion from an expert regarding the development of the repetitive-use software asset.

8. The computing system as claimed in claim 7, wherein the assessment module is further configured to suggest deferring the development of the repetitive-use software asset, based in part on the opinion of the expert.

9. The computing system as claimed in claim 6, wherein the acquiring module is further configured to obtain a plurality of votes regarding the development of the repetitive-use software asset, based on the use-commitment indicator.

10. The computing system as claimed in claim 6 further comprising an information module configured to provide the specifications of the repetitive-use software asset for access on an open platform.

11. A non-transitory computer-readable medium having embodied thereon a computer program for executing a method comprising:
publishing specifications of a repetitive-use software asset on an open platform over a network;
acquiring a demand parameter associated with the repetitive-use software asset based on the specifications of the repetitive-use software asset;
obtaining a use-commitment indicator for using the repetitive-use software asset based on the acquired demand of the repetitive-use software asset;
receiving a plurality of votes regarding development of the repetitive-use software asset based on the use-commitment indicator; and
generating a recommendation for developing the repetitive-use software asset based on a predetermined proportion of votes from among the plurality of votes in favour of the development of the repetitive-use software asset.

12. The non-transitory computer-readable medium as claimed in claim 11, wherein the publishing the specifications comprises populating a template presentation with specifications of the repetitive-use software asset.

13. The non-transitory computer-readable medium as claimed in claim 11, wherein the generating the recommendation comprises obtaining an approval of an expert for the development of the repetitive-use software asset based on the predetermined proportion of votes in favour of the development of the repetitive-use software asset.

14. The non-transitory computer-readable medium as claimed in claim 11, wherein the generating the recommendation comprises providing a suggestion for deferring development of the multi-application software asset.
